(19) United States
(12) Patent Application Publication
(10) Pub. No.: US 2016/0293110 A1
(43) Pub. Date: Oct. 6, 2016

(54) ELECTRO-OPTICAL DISPLAY DEVICE, ELECTRONIC APPARATUS, AND DRIVING METHOD

(71) Applicant: Seiko Epson Corporation, Tokyo (JP)

(72) Inventor: Katsunori Yamazaki, Matsumoto-shi (JP)

(21) Appl. No.: 15/067,112

(22) Filed: Mar. 10, 2016

(30) Foreign Application Priority Data
Mar. 31, 2015 (JP) 2015-072385

(51) Int. Cl. G09G 3/34; G09G 3/20

(52) U.S. Cl. CPC G09G 3/344; G09G 3/2003; G09G 2300/0426; G09G 2330/021

(57) ABSTRACT

An electro-optical display device includes a first substrate on which a plurality of pixel electrodes are provided; a second substrate on which an opposing electrode that faces the pixel electrodes and is divided into a plurality of segments is provided; an image forming unit that is provided between the first substrate and the second substrate and forms a display image according to an electric potential applied to the pixel electrodes and an electric potential applied to the opposing electrode; and a control unit that causes the image forming unit to form a display image based on a first display mode in which approximately the same electric potential is applied to a part or all of the segments in the opposing electrode and a second display mode in which approximately the same electric potential is applied to one or more of the pixel electrodes.

### BACKGROUND

1. Technical Field

The present invention relates to an electro-optical display device, an electronic apparatus, and a driving method.

2. Related Art

A display device which displays a display image using electrophoretic particles, flying particulate, electrochromic material, or the like, has been studied and developed.

In regard to this, a display device which configures a display unit using any one of an electrophoretic panel of a segment system and an electrophoretic panel of an active matrix system has been known (refer to JP-A-2010-197563).

However, when the electrophoretic panel of the segment system is adopted as the display unit, in the display device, it is not possible to realize a high definition display compared to a case where the electrophoretic panel of the active matrix system is adopted. On the other hand, when the electrophoretic panel of the active matrix system is adopted as the display unit, in the display device, it is not possible to perform rewriting of a display image at a high speed compared to a case where the electrophoretic panel of the segment system is adopted.

### SUMMARY

An advantage of some aspects of the invention is to provide an electro-optical display device, an electronic apparatus, and a driving method which can display a high definition image at a high speed.

According to an aspect of the invention, there is provided an electro-optical display device that includes a first substrate on which a plurality of pixel electrodes are provided; a second substrate on which an opposing electrode that faces the pixel electrodes and is divided into a plurality of segments is provided; an image forming unit that is provided between the first substrate and the second substrate and forms a display image according to an electric potential applied to the pixel electrodes and an electric potential applied to the opposing electrode; and a control unit that causes the image forming unit to form a display image based on a first display mode in which approximately the same electric potential is applied to a part or all of the segments in the opposing electrode and a second display mode in which approximately the same electric potential is applied to one or more of the pixel electrodes.

According to the configuration, the electro-optical display device causes the image forming unit to form a display image based on the first display mode in which approximately the same electric potential is applied to a part, or all of the segments in the opposing electrode, and the second display mode in which approximately the same electric potential is applied to one or more of the pixel electrodes. In this manner, the electro-optical display device can display a high definition image at a high speed.

In the electro-optical display device, the first display mode may be an active matrix display mode, and the second display mode may be a segment display mode.

According to the configuration, the electro-optical display device causes the image forming unit to form a display image based on the active matrix display mode and the segment display mode. In this manner, the electro-optical display device can display a high definition image at a high speed, based on the active matrix display mode and the segment display mode.

In the electro-optical display device, a time interval in which the image forming unit forms a display image in the first display mode may be longer than a time interval in which the image forming unit forms a display image in the second display mode.

According to the configuration, the electro-optical display device causes the image forming unit to form a display image in the first display mode at a time interval that is longer than a time interval in which the image forming unit is caused to form a display image in the second display mode. In this manner, the electro-optical display device can suppress a frequency of forming a display image by the image forming unit using the first display mode.

According to another aspect of the invention, there is provided an electronic apparatus that includes any one of the electro-optical display devices.

According to the configuration, the electronic apparatus causes the image forming unit to form a display image based on a first display mode in which approximately the same electric potential is applied to a part, or all of segments in the opposing electrode, and a second display mode in which approximately the same electric potential is applied to one or more of pixel electrodes. In this manner, the electronic apparatus can display a high definition image at a high speed.

According to still another aspect of the invention, there is provided a driving method of an electro-optical display device that includes a first substrate on which a plurality of pixel electrodes are provided; a second substrate on which an opposing electrode that faces the pixel electrodes and is divided into a plurality of segments is provided; and an image forming unit that is provided between the first substrate and the second substrate and forms a display image according to an electric potential applied to the pixel electrodes and an electric potential applied to the opposing electrode, the driving method including causing the image forming unit to form a display image based on a first display mode in which approximately the same electric potential is applied to a part or all of the segments in the opposing electrode and a second display mode in which approximately the same electric potential is applied to one or more of the pixel electrodes.

According to the configuration, in the driving method, the image forming unit is caused to form a display image based on the first display mode in which approximately the same electric potential is applied to a part, or all of the segments in the opposing electrode, and the second display mode in which approximately the same electric potential is applied to one or more of the pixel electrodes. In this manner, in the driving method, it is possible to display a high definition image at a high speed.

As described above, in the electro-optical display device, the electronic apparatus, and the driving method, the image forming unit is caused to forma display image based on the first display mode in which approximately the same electric potential is applied to a part, or all of the segments in the opposing electrode, and the second display mode in which approximately the same electric potential is applied to one or more of the pixel electrodes. In this manner, in the electro-optical display device, the electronic apparatus, and the driving method, it is possible to display a high definition image at a high speed.

### BRIEF DESCRIPTION OF THE DRAWINGS

The invention will be described with reference to the accompanying drawings, wherein like numbers reference like elements.

FIG. 1 is a diagram illustrating an example of an appearance of an electronic apparatus according to an embodiment.

FIG. 2 is a diagram illustrating an example of a configuration of an electro-optical display device.

FIG. 3 is a diagram illustrating an example of a circuit configuration of a pixel in a display unit of the electro-optical display device.

FIG. 4 is a diagram illustrating an example of an electrical configuration of the electro-optical display device along with a sectional structure thereof.

FIG. 5 is a diagram illustrating an example of a circuit configuration of an opposing electrode which is divided into a plurality of segments.

FIG. 6 is a schematic sectional view of a microcapsule.

FIG. 7 is a diagram illustrating an example of a shape of the opposing electrode in the electro-optical display device.

FIG. 8 is a timing chart in specific example 1 of a control method of the electro-optical display device.

FIG. 9 is a timing chart in specific example 2 of the control method of the electro-optical display device.

FIG. 10 is a timing chart in specific example 3 of the control method of the electro-optical display device.

FIG. 11 is a diagram in which a segment display mode period T4b is changed to a segment display mode period T4c in the timing chart illustrated in FIG. 10.

FIG. 12 is a diagram illustrating another display example of the electro-optical display device.

FIG. 13 is a diagram illustrating an example of a multilayered structure of the segment in the electro-optical display device.

FIG. 14 is a diagram illustrating an example of an electrical configuration of a pixel.

FIGS. 15A and 15B are diagrams illustrating other specific examples of an electronic apparatus that includes the electro-optical display device according to the embodiment.

### DESCRIPTION OF EXEMPLARY EMBODIMENTS

### Embodiment

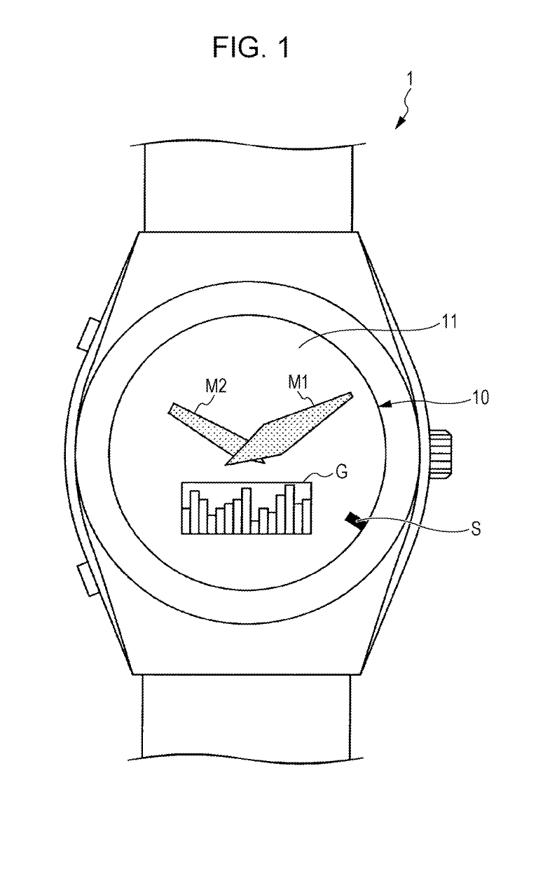

Hereinafter, an embodiment of the invention will be described with reference to drawings. FIG. 1 is a diagram illustrating an example of an appearance of an electronic apparatus 1 according to the embodiment. As illustrated in FIG. 1, the electronic apparatus 1 is a watch which includes an electro-optical display device 10. The electronic apparatus 1 displays a minute hand M1, a hour hand M2, a second hand S, and a graph G on a display unit 11 of the electro-optical display device 10. The graph G is, for example, a histogram that denotes the number of steps per hour of a user who wears the electronic apparatus 1.

In addition, the electronic apparatus 1 may have a configuration of displaying other information in addition to these, and may have a configuration of displaying other information without displaying a part, or all of these. In addition, the graph G may be another graph. The electronic apparatus 1 may be another electronic apparatus that includes the electro-optical display device 10, instead of a watch. Hereinafter, a figure or characters, a number, and a sign which are displayed on the electro-optical display device 10 using the electronic apparatus 1 will be described by being referred to as a display image.

The electro-optical display device 10 displays a display image on the display unit 11 using two display modes of an active matrix display mode and a segment display mode.

The active matrix display mode is a display mode in which a display image is displayed on the display unit 11 using electrophoresis of an active matrix system. That is, in the active matrix display mode, the electro-optical display device 10 displays various display images on the display unit 11 by changing a color of a pixel by applying a voltage to each pixel which forms a display image on the display unit 11.

In the active matrix display mode, the electro-optical display device 10 determines a color of each pixel which forms a display image on the display unit 11 based on image data. The electro-optical display device 10 generates, for example, image date of the minute hand M1 and the hour hand M2 corresponding to a point of time which is measured using a time measuring unit that is not illustrated. In addition, for example, the electro-optical display device 10 measures the number of steps of a user who moves by wearing the electronic apparatus 1 based on acceleration which is generated in the electronic apparatus 1, and is detected from an acceleration sensor (not illustrated), and generates image data of the graph G based on the measured number of steps. In addition, the electro-optical display device 10 may have a configuration of obtaining the image data from another device.

The electro-optical display device 10 applies a voltage corresponding to a color of a pixel which is determined based on the generated image data to each pixel of the display unit 11. In this manner, the electro-optical display device 10 can display a high definition display image based on the image data. That is, the electro-optical display device 10 can display a high definition display image using the active matrix display mode. In the example, displaying of a high definition display image means displaying of a display image in which a shape is changed according to a change in some values of passage of time, a change in temperature, and the like. In the example, the electro-optical display device 10 displays the minute hand M1, the hour hand M2, and the graph G using the active matrix display mode.

The segment display mode is a display mode in which a display image is displayed on the display unit 11 using electrophoresis of a segment system. That is, in the segment display mode, the electro-optical display device 10 applies a voltage to a group (segment) of a part of each pixel which forms a display image on the display unit 11. In addition, the electro-optical display device 10 displays a display image corresponding to a shape of a segment on the display unit 11 by changing a color of a segment in each segment.

That is, the electro-optical display device 10 can display a display image in a predetermined shape without generating image data at a timing corresponding to a change in some values such as passage of time, a change in temperature, and the like, using the segment display mode. In the example, the electro-optical display device 10 displays the second hand S using the segment display mode.

In addition, in the segment display mode, the electro-optical display device 10 does not perform a process which is necessary for applying a voltage based on generated image data to each pixel of the display unit 11. In this manner, in the segment display mode, the electro-optical display device 10 can display a display image corresponding to a predetermined shape of a segment earlier than a case of displaying the display image using the active matrix display mode, and as a result, it is possible to reduce an amount of power consumption.

In this manner, the electro-optical display device 10 displays a display image based on the active matrix display mode and the segment display mode. Due to this, the electro-optical display device 10 can display a high definition image at a high speed.

Hereinafter, a configuration of the electro-optical display device 10, and a control method in which the electro-optical display device 10 causes the display unit 11 to display a display image will be described in detail. Configuration of electro-optical display device 10

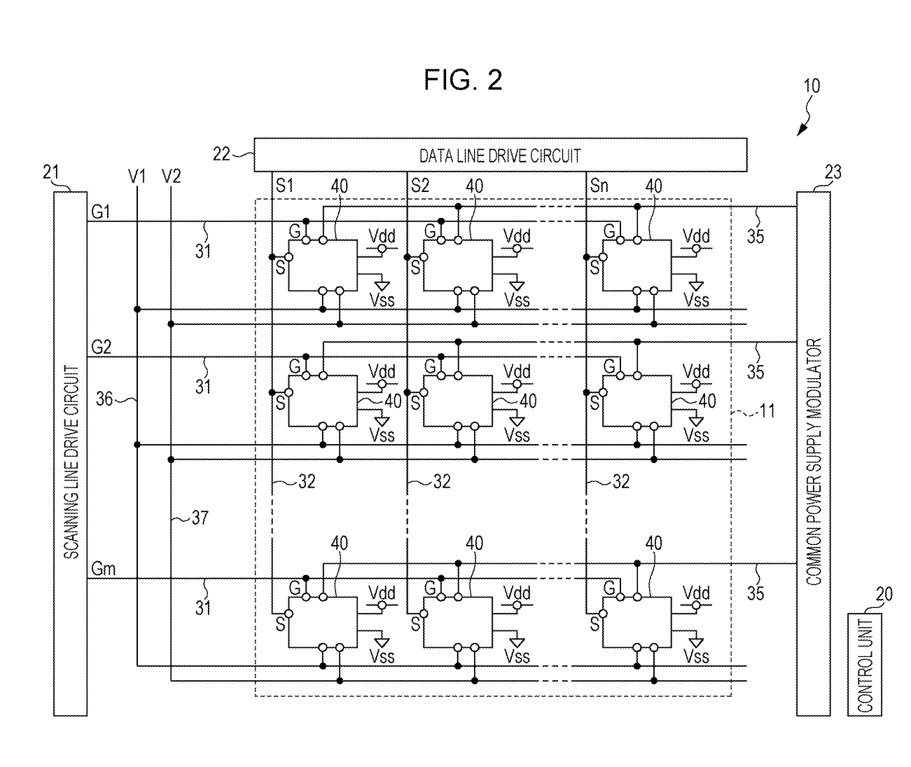

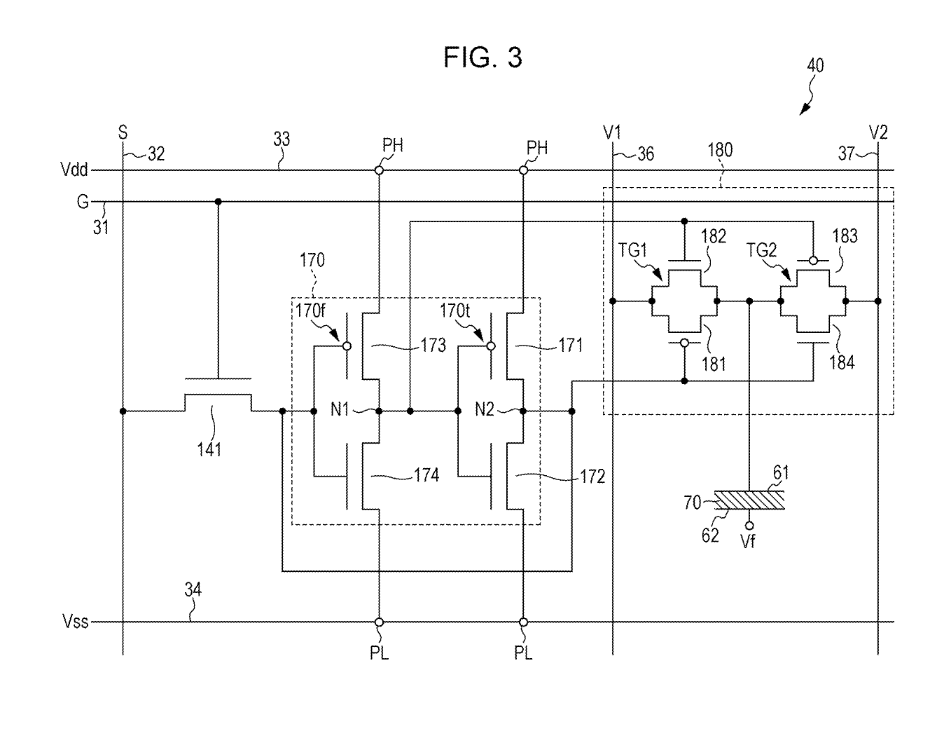

Hereinafter, the configuration of the electro-optical display device 10 will be described with reference to FIGS. 2 to 6. FIG. 2 is a diagram illustrating an example of the configuration of the electro-optical display device 10. In addition, FIG. 3 is a diagram illustrating an example of a circuit configuration of a pixel 40 in the display unit 11 of the electro-optical display device 10.

The electro-optical display device 10 includes the display unit 11 in which a plurality of the pixels 40 are arranged, a control unit 20, a scanning line driving circuit 21, a data line driving circuit 22, and a common power supply modulation circuit 23.

In FIG. 2, in order to simplify the drawing, a case where the display unit 11 of the electro-optical display device 10 is in a quadrangle shape, and the plurality of pixels 40 are regularly aligned so as to form a matrix vertically and horizontally in the quadrangle shape is illustrated. The display unit 11 of the electro-optical display device 10 illustrated in FIG. 1 is formed by regularly aligning the plurality of pixels 40 which are regularly aligned so as to form the matrix, in order to form a matrix in a circular shape. In descriptions of the configuration of the electro-optical display device 10 in FIGS. 2, 3 and 5, a case where the display unit 11 of the electro-optical display device 10 is in the quadrangle shape is exemplified; however, a configuration of the electro-optical display device 10 is also the same in the case where the display unit 11 is in the circular shape, as illustrated in FIG. 1.

A plurality of scanning lines 31 which extend from the scanning line driving circuit 21, and a plurality of data lines 32 which extend from the data line driving circuit 22 are formed in the display unit 11, and the pixels 40 are provided corresponding to intersecting positions of these. In addition, the display unit 11 is provided with a high electric potential power line 33 (refer to FIG. 3) which is a power line that extends from the common power supply modulation circuit 23 and applies an electric potential Vdd, and the high electric potential power line is connected to each pixel 40. In addition, the display unit 11 is provided with a low electric potential power line 34 (refer to FIG. 3) which is a power line that extends from the common power supply modulation circuit 23 and applies a electric potential Vss, and the low electric potential power line is connected to each pixel 40. In addition, the display unit 11 is provided with common electrode wiring 35 which extends from the common power supply modulation circuit 23, a first control line 36, and a second control line 37, and respective wiring are connected to the pixel 40.

The control unit 20 comprehensively controls these functional units based on image data generated in the own device and image data obtained from another device. In addition, in FIG. 2, wiring that connects the control unit 20 and other functional units is omitted in order to prevent the figure from being complicated.

The scanning line driving circuit 21 is connected to each pixel 40 through the scanning line 31. The scanning line driving circuit 21 sequentially selects the scanning lines 31 from the first line (G1) to the mth line (Gm) under a control of the control unit 20, and supplies a selection signal that defines an on-timing of a selection transistor 141 (refer to FIG. 3) provided in the pixel 40 through a selected scanning line 31.

The data line driving circuit 22 is connected to each pixel 40 through the data line 32. The data line driving circuit 22 supplies an image signal that defines pixel data of one bit to the pixel 40 in a selection period of the scanning line 31.

The common power supply modulation circuit 23 generates various signals to be supplied to each of the above described wiring under a control of the control unit 20, and performs an electrical connection and a disconnection of each wiring of theses. In addition, a first control line 36 is connected to the common power supply modulation circuit 23. The common power supply modulation circuit 23 is connected to a switch circuit 180 which will be described later through the first control line 36. The common power supply modulation circuit 23 applies a voltage V1 to a pixel electrode 61 which will be described later, and is included in a pixel 40 that is connected to the switch circuit 180 through the first control line 36. In addition, the common power supply modulation circuit 23 changes a value of the electric potential V1 under a control of the control unit 20. In the example, the common power supply modulation circuit 23 changes the electric potential V1 to any one of a +V voltage and a zero voltage. In addition, a second control line 37 is connected to the common power supply modulation circuit 23. The common power supply modulation circuit 23 is connected to the switch circuit 180 through the second control line 37. The common power supply modulation circuit 23 applies a voltage V2 to the pixel electrode 61, which will be described later, which is included in a pixel 40 connected to the switch circuit 180 through the second control line 37. In addition, the common power supply modulation circuit 23 changes a value of the electric potential V2 under a control of the control unit 20. In the example, the common power supply modulation circuit 23 changes the electric potential V2 to any one of a +V voltage and a zero voltage.

The pixel electrode 61, an opposing electrode 62, an image forming unit 70, the selection transistor 141, a latch circuit 170, and the switch circuit 180 are provided in the pixel 40. The scanning line 31, the data line 32, the high electric potential power line 33, a low electric potential power line 34, the first control line 36, and the second control line 37 are arranged so as to surround these elements. The pixel 40 has a configuration of a Static Random Access Memory (SRAM) system in which an image signal is held as an electric potential using the latch circuit 170.

The selection transistor 141 is a pixel switching element formed of a Negative Metal Oxide Semiconductor (N-MOS) transistor. A gate terminal of the selection transistor 141 is connected to the scanning line 31, a source terminal is connected to the data line 32, and a drain terminal is connected to a data input terminal N1 of the latch circuit 170. The data input terminal N1 and a data output terminal N2 of the latch circuit 170 are connected to the switch circuit 180. In addition, the switch circuit 180 is connected to the pixel electrode 61, and is connected to the first control line 36 and the second control line 37.

The image forming unit 70 is interposed between the pixel electrode 61 and the opposing electrode 62.

The latch circuit 170 includes a transfer inverter 170t and a feedback inverter 170f which are both C-MOS inverters. The transfer inverter 170t and the feedback inverter 170f form a loop structure in which an output terminal of the other side is connected to an input terminal of each other, and a power supply voltage is supplied to the respective inverter from the high electric potential power line 33 that is connected through a high electric potential power supply terminal PH, and the low electric potential power line 34 that is connected through a low electric potential power supply terminal PL.

The transfer inverter 170t includes a Positive Metal Oxide Semiconductor (P-MOS) transistor 171 and an N-MOS transistor 172 of which respective drain terminals are connected to the data output terminal N2. A source terminal of the P-MOS transistor 171 is connected to the high electric potential power supply terminal PH, and a source terminal of the N-MOS transistor 172 is connected to the low electric potential power supply terminal PL. Gate terminals of the P-MOS transistor 171 and the N-MOS transistor 172 (input terminal of transfer inverter 170t) are connected to the data input terminal N1 (output terminal of feedback inverter 170f).

The feedback inverter 170f includes a P-MOS transistor 173 and an N-MOS transistor 174 of which respective drain terminals are connected to the input terminal N1. Gate terminals of the P-MOS transistor 173 and the N-MOS transistor 174 (input terminal of feedback inverter 170f) are connected to the data output terminal N2 (output terminal of transfer inverter 170t).

In the latch circuit 170 with the above described configuration, when an image signal of a high level (H) (image data “1”) is stored, a low level (L) signal is output from the data output terminal N2 of the latch circuit 170. On the other hand, when an image signal of a low level (L) (image data “0”) is stored in the latch circuit 170, a high level (H) signal is output from the data output terminal N2.

The switch circuit 180 includes a first transmission gate TG1, and a second transmission gate TG2.

The first transmission gate TG1 is formed of a P-MOS transistor 181 and an N-MOS transistor 182. Source terminals of the P-MOS transistor 181 and the N-MOS transistor 182 are connected to the first control line 36, and drain terminals of the P-MOS transistor 181 and an N-MOS transistor 182 are connected to the pixel electrode 61. In addition, a gate terminal of the P-MOS transistor 181 is connected to the data input terminal N1 of the latch circuit 170, and a gate terminal of the N-MOS transistor 182 is connected to the data output terminal N2 of the latch circuit 170.

The second transmission gate TG2 is formed of a P-MOS transistor 183 and an N-MOS transistor 184. Source terminals of the P-MOS transistor 183 and the N-MOS transistor 184 are connected to the second control line 37, and drain terminals of the P-MOS transistor 183 and the N-MOS transistor 184 are connected to the pixel electrode 61. In addition, a gate terminal of the P-MOS transistor 183 is connected to the data output terminal N2 of the latch circuit 170, and a gate terminal of the N-MOS transistor 184 is connected to the data input terminal N1 of the latch circuit 170.

Here, when an image signal of a low level (L) (image data “0”) is stored in the latch circuit 170, and a high level signal (H) is output from the data output terminal N2, the first transmission gate TG1 enters an ON-state, and the electric potential V1 which is supplied through the first control line 36 is input to the pixel electrode 61. In the example, a value of the electric potential V1 is any one of a +V voltage and a zero voltage.

Meanwhile, when an image signal of a high level (H) (image data “1”) is stored in the latch circuit 170, and a low level signal (L) is output from the data output terminal N2, the second transmission gate TG2 enters an ON-state, and the electric potential V2 which is supplied through the second control line 37 is input to the pixel electrode 61. In the example, a value of the electric potential V2 is any one of a +V voltage and a zero voltage.

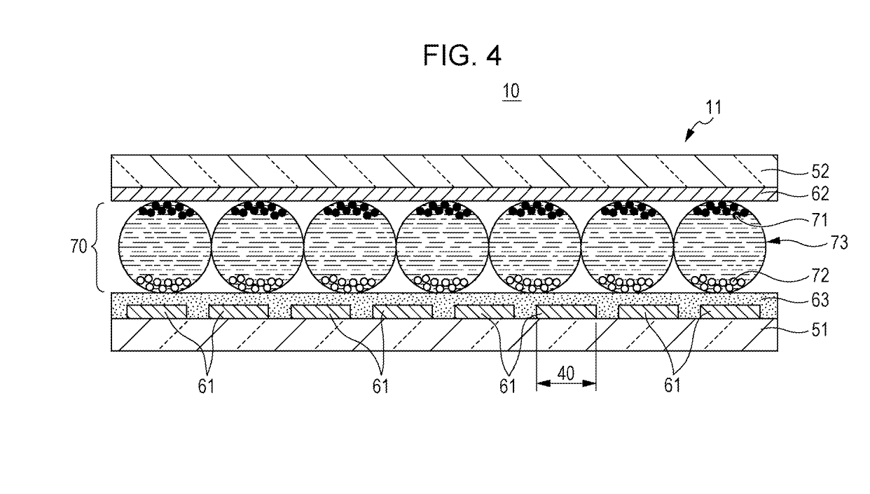

Subsequently, a sectional structure and an electrical configuration of the electro-optical display device 10 will be described with reference to FIG. 4. FIG. 4 is a diagram illustrating an example of the sectional structure and the electrical configuration of the electro-optical display device 10. As illustrated in FIG. 4, the display unit 11 of the electro-optical display device 10 has a configuration of interposing the image forming unit 70 between a first substrate 51 and a second substrate 52. The plurality of pixel electrodes 61 are formed on the image forming unit 70 side of the first substrate 51, and the opposing electrode 62 is formed on the image forming unit 70 side of the second substrate 52.

The image forming unit 70 is, for example, an electrophoretic element having a plurality of the microcapsules 73 in which electrophoretic particles are enclosed are planarly arranged. The electro-optical display device 10 according to the embodiment displays an image which is formed using the image forming unit 70 on the opposing electrode 62 side. In addition, the image forming unit 70 may be another element such as an element having a plurality of microcapsules in which flying particulates are enclosed are planarly arranged, instead of the electrophoretic element, when it is an element that can change a color of a pixel by being applied with a voltage.

The first substrate 51 is a substrate which is formed of glass, plastic, or the like, and may not be transparent, since the substrate is arranged on a side opposite to an image display face. The pixel electrode 61 is an electrode that supplies a voltage to the image forming unit 70 formed of a material obtained by stacking nickel plating and gold plating on copper (Cu) foil in this order, and aluminum (AL), indium tin oxide (ITO), or the like.

The scanning line driving circuit 21 is connected to each pixel electrode 61 through the scanning line 31. A switching element (not illustrated) which corresponds to each of the scanning lines 31 is provided in the scanning line driving circuit 21.

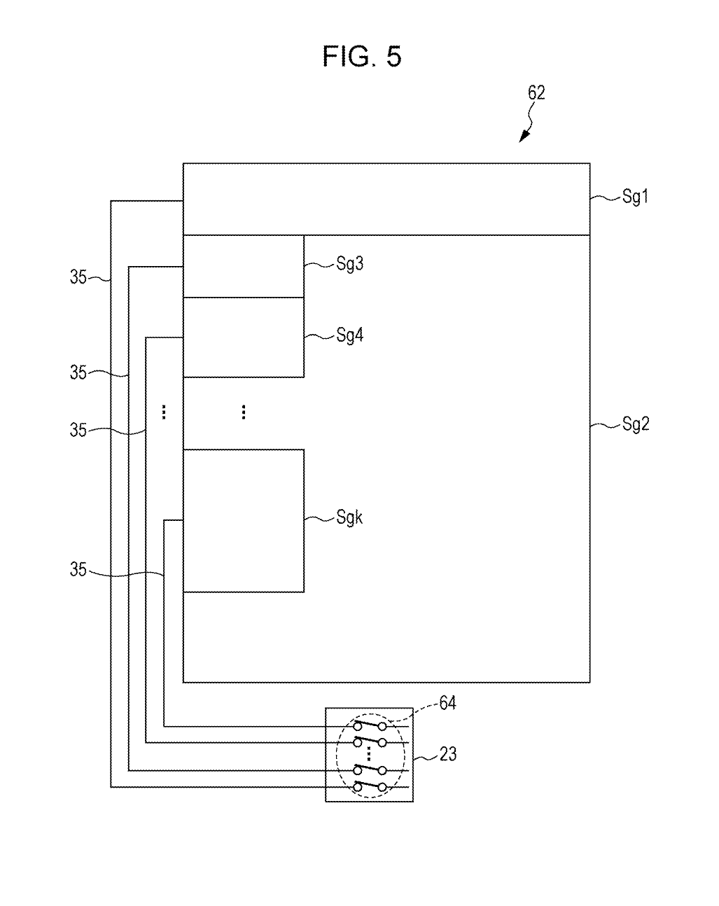

Meanwhile, the second substrate 52 is a substrate formed of glass, plastic, or the like, and is a transparent substrate since the substrate is arranged on the image displaying side. The opposing electrode 62 is an electrode that supplies a voltage to the image forming unit 70 along with the pixel electrode 61, and is a transparent electrode formed of magnesium silver (MgAg), ITO, indium zinc oxide (IZO), or the like. In the electro-optical display device 10, the opposing electrode 62 is divided into a plurality of segments as illustrated in FIG. 5.

Here, the opposing electrode 62 which is divided into a plurality of segments will be described with reference to FIG. 5. FIG. 5 is a diagram illustrating an example of a circuit configuration of the opposing electrode 62 which is divided into a plurality of segments. In FIG. 5, the opposing electrode 62 is divided into k segments of segment Sg1 to segment Sgk. The variable k is a constant of 2 or more. Hereinafter, the segment Sg1 to segment Sgk will be collectively described as a segment Sg when it is not necessary to distinguish the segments.

The common power supply modulation circuit 23 is connected to the opposing electrode 62 of each of the plurality of segments Sg through common electrode wiring 35. The common power supply modulation circuit 23 includes a switching element 64 (refer to FIG. 5). The common power supply modulation circuit 23 performs an electrical connection and a disconnection with the opposing electrode 62 of each of the plurality of segments Sg, by causing the plurality of switching elements 64 to be operated under a control of the control unit 20. The common power supply modulation circuit 23 applies a voltage Vf to the opposing electrode 62 by turning on a switch of the switching element 64. In the example, a value of the voltage Vf is any one of a +V voltage and a zero voltage.

In addition, in general, the image forming unit 70 is formed on the second substrate 52 side in advance, and is treated as an electrophoretic sheet that also includes an adhesive layer 63. In a manufacturing process, the electrophoretic sheet is treated in a state where a protective releasable sheet is attached to the surface of the adhesive layer 63. In addition, the display unit 11 is formed by bonding the electrophoretic sheet from which the releasable sheet is separated to the first substrate 51 (on which pixel electrode 61, or the like, is formed) that is separately manufactured. For this reason, the adhesive layer 63 is present only on the pixel electrode 61 side.

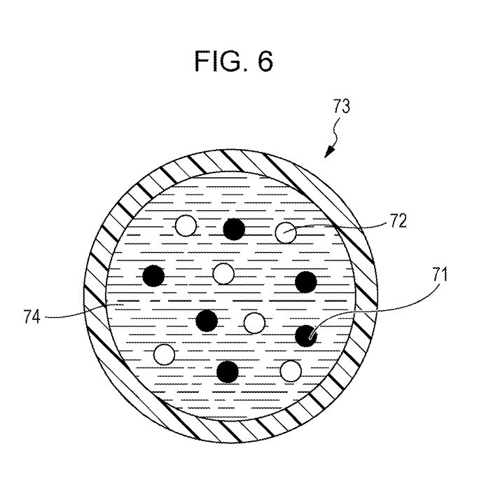

FIG. 6 is a schematic sectional view of the microcapsule 73. The microcapsule 73 has a particle diameter of approximately 30 micrometer to 50 micrometer, for example, and is a spherical body in which a plurality of black particles (electrophoretic particles) 71, a plurality of white particles (electrophoretic particles) 72, and a dispersion medium 74 are enclosed. As illustrated in FIG. 4, the microcapsule 73 is interposed between the pixel electrode 61 and the opposing electrode 62, and one, or a plurality of microcapsules 73 are arranged in one pixel 40.

A shell portion (wall film) of the microcapsule 73 is formed using a high polymer resin with transmittance such as an acrylic resin such as polymethyl methacrylate and polymethacrylic acid ethyl, a urea resin, and gum Arabic.

The dispersion medium 74 is liquid which uses the black particles 71 and the white particles 72 to be dispersed in the microcapsule 73. As the dispersion medium 74, water, an alcohol solvent (methanol, ethanol, butanol, octanol, methyl cellosolve, or the like), ester (ethyl acetate, butyl acetate, or the like), ketone (acetone, methyl ethyl ketone, methyl isobutyl ketone, or the like), aliphatic hydrocarbon (pentane, hexane, octane, or the like), alicyclic hydrocarbon (cyclohexane, methyl cyclohexane, or the like), aromatic hydrocarbon (benzene, toluene, benzene with long chain alkyl group (xylene, hexyl benzene, butyl benzene, octyl benzene, nonyl benzene, decyl benzene, undecyl benzene, dodecyl benzene, tridecyl benzene, tetradecyl benzene, or the like)), halogenated hydrocarbon (methyl chloride, chloroform, carbon tetrachloride, 1,2-dichloroethane, or the like), carboxylate, and the like, can be exemplified, and it may be oil other than those. These substances can be used alone, or as a mixture, and a surfactant, or the like, may be further compounded therein.

The black particles 71 are particles which are formed of a black pigment such as aniline black and carbon black (high polymer or colloid), for example, and are used by being positively charged, for example.

The white particles 72 are particles which are formed of a white pigment such as Titanium dioxide, hydrozincite, antimony trioxide (high polymer or colloid), for example, and are used by being negatively charged, for example.

In these pigments, it is possible to add a charge control agent which is formed of particles such as an electrolyte, a surfactant, metallic soap, a resin, rubber, oil, varnish, and a compound, dispersant such as a titanium coupling agent, an aluminum coupling agent, and a silane coupling agent, and lubricant, a stabilizer, and the like.

In addition, a pigment of red, green, blue, and the like, for example, may be used instead of the black particles 71 and the white particles 72. According to the configuration, it is possible to display a red color, a green color, a blue color, and the like, on the display unit 11.

Here, operations of the image forming unit 70 will be described.

In the electro-optical display device 10, an electric potential corresponding to image data is input to the pixel electrode 61 of the pixel 40 through data line 32 from the data line driving circuit 22, and meanwhile, an electric potential Vf is input to the opposing electrode 62 through the common electrode wiring 35 from the common power supply modulation circuit 23. That is, the electric potential Vf is input to the opposing electrode 62 which is illustrated in FIG. 3, using the common electrode wiring 35. The pixel 40 is displayed in black or in white based on an electric potential difference between the pixel electrode 61 and the opposing electrode 62 which occurs due to this.

When the pixel 40 is displayed in white, the opposing electrode 62 is maintained at a high electric potential, relatively, and the pixel electrode 61 is maintained at a low electric potential, relatively. Due to this, the white particles 72 which are negatively charged are pulled to the opposing electrode 62, and meanwhile, the black particles 71 which are positively charged are pulled to the pixel electrode 61. As a result, when the pixel is viewed from the opposing electrode 62 side which is the display face side, a white color is recognized.

When the pixel 40 is displayed in black, the opposing electrode 62 is maintained at a low electric potential, relatively, and the pixel electrode 61 is maintained at a high electric potential, relatively. Due to this, the black particles 71 which are positively charged are pulled to the opposing electrode 62, and meanwhile, the white particles 72 which are negatively charged are pulled to the pixel electrode 61. As a result, when the pixel is viewed from the opposing electrode 62 side, a black color is recognized.

Shape of opposing electrode 62 and display example of electro-optical display device 10

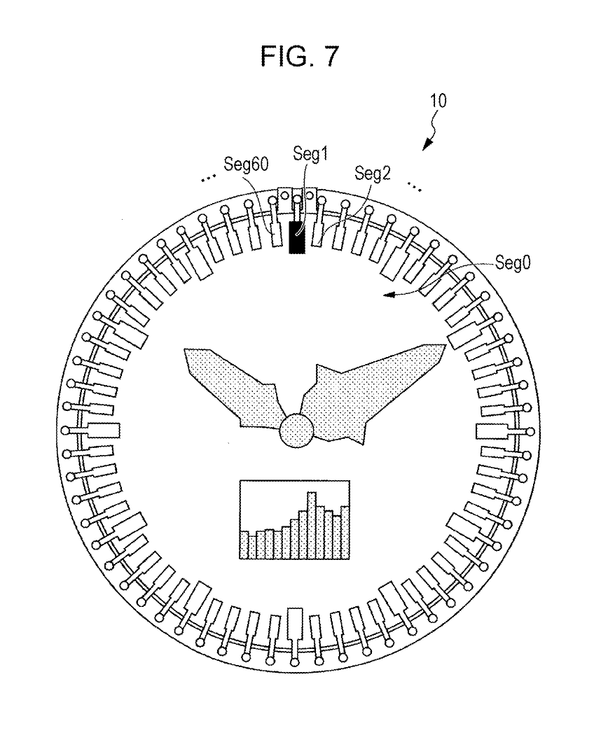

Hereinafter, a shape of the opposing electrode 62 in the electro-optical display device 10 in FIG. 1, and a display example of a display image which is displayed on the display unit 11 according to the shape of the opposing electrode 62 will be described with reference to FIG. 7. FIG. 7 is a diagram illustrating an example of a shape of the opposing electrode 62 in the electro-optical display device 10. In FIG. 7, the opposing electrode 62 is divided into 61 segments. Hereinafter, for ease of descriptions, respective opposing electrodes 62 which are divided into 61 segments will be described by being referred to as segment Seg 0 to segment Seg 60.

The segment Seg 1 to segment Seg 60 are segments for displaying the second hand S illustrated in FIG. 1. In the example, the segment Seg 1 is a segment in a shape of a second hand of one second of the electronic apparatus 1 as a watch. In addition, the segment Seg 2 is a segment in a shape of the second hand of 2 seconds of the electronic apparatus 1 as the watch. In this manner, it is continuous to the segment Seg 60, and the segment Seg 60 is a segment in a shape of the second hand of 60 seconds (that is, zero second) of the electronic apparatus 1 as the watch.

The segment Seg 0 is a largest segment in the plurality of segments of the display unit 11 of the electro-optical display device 10. In FIG. 7, the segment Seg 0 is a disk-shaped segment for displaying the minute hand M1, the hour hand M2, and the graph G. The disk-shaped segment Seg 0 includes sixty notch portions into which the respective segment Seg 1 to segment Seg 60 are fitted at positions at which respective second hands of 1 second to 60 seconds of the electronic apparatus 1 as the watch are displayed. In FIG. 7, a state where the respective segment Seg 1 to segment Seg 60 are fitted into the respective sixty notch portions is illustrated.

For example, the electro-optical display device 10 displays the minute hand M1, the hour hand M2, and the graph G in the segment Seg 0 as illustrated in FIG. 7, when it is 10 o'clock, 10 minutes, and a zero second. In addition, the electro-optical display device 10 sets the segment Seg 1 to a state of a black display, and sets the segment Seg 2 to segment Seg 60 to a state of a white display. The electro-optical display device 10 maintains a display state of the minute hand M1, the hour hand M2, and the graph G which are displayed in the segment Seg 0, when it is 10 o'clock, 10 minutes, and one second, and changes the segment Seg 1 to a state of the white display. Thereafter, the electro-optical display device 10 changes the segment Seg 2 to a state of the black display, and maintains the segment Seg 3 to segment Seg 60 at the white display as is.

This process is repeated, and when it is 10 o'clock, 11 minutes, and a zero second, the electro-optical display device 10 changes the minute hand M1 and the hour hand M2 which are displayed in the segment Seg 0 to a display that denotes 10 o'clock and 11 minutes. In addition, the electro-optical display device 10 changes the segment Seg 59 to a state of the white display, and changes the segment Seg 60 to a state of the black display. In addition, in the example, the electro-optical display device 10 may change the graph G which is displayed in the segment Seg 0, and may not change the graph G between 10 o'clock, 10 minutes, a zero second and 10 o'clock, 11 minutes, a zero second.

The electro-optical display device 10 performs displaying of a point of time using the minute hand M1, the hour hand M2, and the second hand S, and displaying of the graph G based on the active matrix display mode and the segment display mode. In the example, the electro-optical display device 10 performs displaying of the minute hand M1, the hour hand M2, and the graph G using the active matrix display mode. In addition, the electro-optical display device 10 performs displaying of the second hand S using the segment display mode.

### Specific Example 1 of Control Method of Electro-Optical Display Device 10

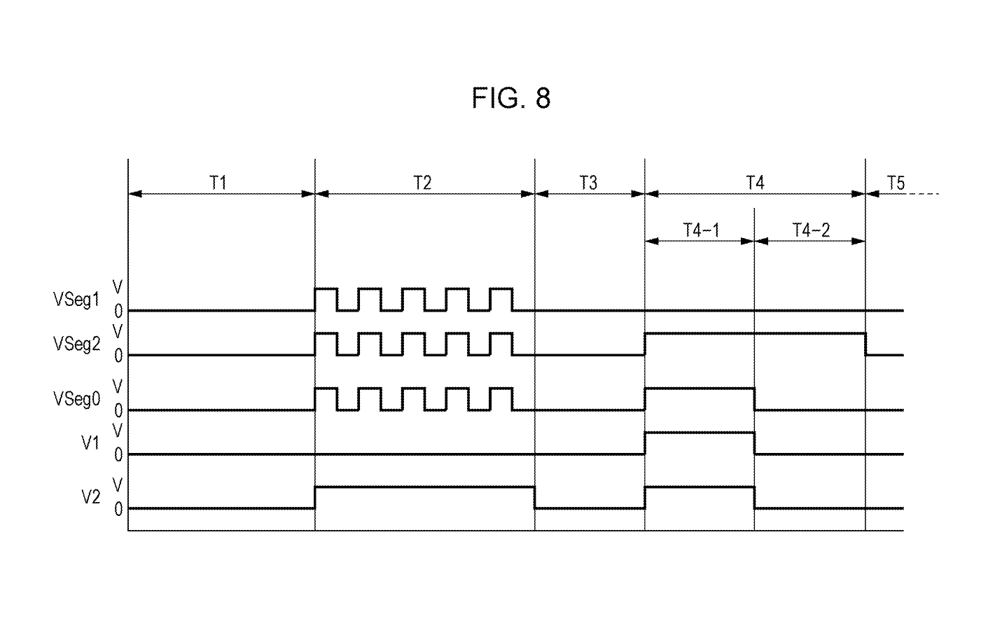

Hereinafter, specific example 1 of a control method of the electro-optical display device 10 according to the embodiment will be described with reference to FIG. 8.

FIG. 8 is a timing chart in specific example 1 of the control method of the electro-optical display device 10. In FIG. 8, a state where the electro-optical display device 10 performs operations in order of an image signal input period T1, a matrix display mode period T2, a power off period T3, a segment display mode period T4, and a repeating period T5, and a display image is displayed is illustrated. In addition, the segment display mode period T4 is divided into a first half and a second half. That is, in the segment display mode period T4, the electro-optical display device 10 performs operations in order of a first segment display mode period T4-1 and a second segment display mode period T4-2.

In FIG. 8, an electric potential Vseg 0 which is applied to the segment Seg 0, an electric potential Vseg 1 which is applied to the segment Seg 1, and an electric potential Vseg 2 which is applied to the segment Seg 2 are illustrated among the electric potential V1 of the first control line 36, the electric potential V2 of the second control line 37, and the electric potential Vf of the common electrode wiring 35. In addition, the specific voltage value of a +V voltage or a zero voltage which is illustrated in FIG. 8 is merely an example, and does not limit a technical range of the invention.

### Control of Causing Pixel 40 to Store Electric Potential Corresponding to Image Data in Image Signal Input Period T1

Hereinafter, the image signal input period T1 will be described.

When an electric potential of approximately 5 voltages (high level; denoted by H (5V)) is input as an electric potential VDD through the high electric potential power line 33, for example, and an electric potential of a zero voltage (low level; denoted by L (0V)) is input as an electric potential Vss through the low electric potential power line 34, for example, to a SRAM which holds an image signal as an electric potential using the latch circuit 170 (refer to FIG. 3) from the common power supply modulation circuit 23 in FIG. 2, in the pixel 40, the SRAM is driven. In addition, the 5 voltages is an example of the +V voltage as the value of the above described electric potential.

At this time, the high electric potential power line 33, the low electric potential power line 34, and the common electrode wiring 35 are electrically disconnected due to the common power supply modulation circuit 23.

The scanning line driving circuit 21 in FIG. 2 inputs a selection signal to a scanning line G1. Due to the selection signal, a pixel switching element of the pixel 40 which is connected to the scanning line G1 is driven, and a SRAM of the pixel 40 which is connected to the scanning line G1 is connected to data lines S1, S2, . . . , Sn, respectively.

The data line driving circuit 22 in FIG. 1 inputs an image signal to the SRAM of the pixel 40 which is connected to the scanning line G1 by supplying an image signal to the data lines S1, S2, . . . , Sn.

When the image signal is input, the scanning line driving circuit 21 stops supplying of a selection signal to the scanning line G1, and releases a selection state of the pixel 40 which is connected to the scanning line G1. This operation is sequentially performed to a pixel 40 which is connected to the scanning line Gm, and an image signal is input to SRAMs of all of pixels 40. In this manner, a electric potential corresponding to image data is stored in the SRAM of the pixel 40 which configure the display unit 11.

### Control of Electro-Optical Display Device 10 in Matrix Display Mode Period T2

Hereinafter, the matrix display mode period T2 will be described.

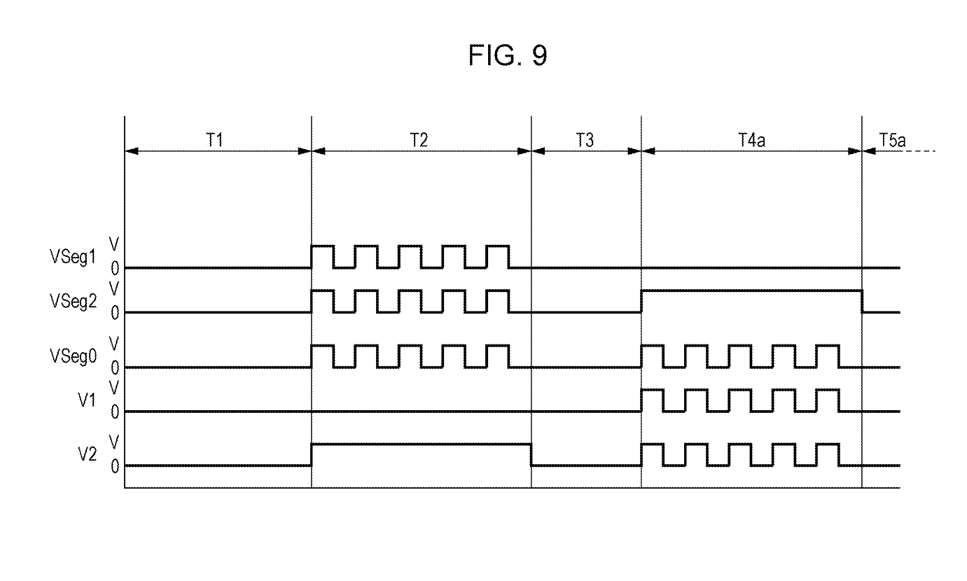

In the matrix display mode period T2, a pulse-like signal in which a high level period (H (15V)) and a low level period (L (0V)) are repeated in a constant period is input to the plurality of segments (in the example, segment Seg 0 to segment Seg 60) through the common power supply modulation circuit 23. In FIG. 9, a state where the pulse-like signal is input to three segments of segment Seg 0 to segment Seg 2 is illustrated.

In the matrix display mode period T2, a voltage of high level (H (15V)) is supplied to the high electric potential power line 33, and an output voltage of the SRAM is also set to L (0V) or H (15V). In addition, hereinafter, a voltage value in the parenthesis is omitted, and will be described as L or H.

In contrast to this, in a pixel 40 of which a pixel signal programmed in the SRAM is a low level among the plurality of pixels 40 that are included in the electro-optical display device 10, the terminal N1 is set to L, and the terminal N2 is set to H. For this reason, the first transmission gate TG1 is turned on, the second transmission gate TG2 is turned off, the pixel electrode 61 and the first control line 36 are electrically connected, and the pixel electrode 61 and the second control line 37 are electrically disconnected. Accordingly, an electric potential of the first control line 36 is supplied to the pixel electrode 61.

Meanwhile, in the pixel 40 in which the pixel signal is a high level, the terminal N1 is set to H, and the terminal N2 is set to L. For this reason, the second transmission gate TG2 is turned on, the first transmission gate TG1 is turned off, the pixel electrode 61 and the second control line 37 are electrically connected, and the pixel electrode 61 and the first control line 36 are disconnected. Accordingly, an electric potential of the second control line 37 is supplied to the pixel electrode 61.

Accordingly, when the common power supply modulation circuit 23 supplies an electric potential of L to the first control line 36, and supplies an electric potential of H to the second control line 37, L is applied to the pixel electrode 61 of the pixel 40 of which a pixel signal programmed in the SRAM is a low level. In addition, negative white particles migrate to the segment side, and positive black particles migrate to the pixel electrode 61 side when electric potentials of the plurality of segments are in the H period. As a result, the pixel 40 becomes a white display.

Meanwhile, H is applied to the pixel electrode 61 of the pixel 40 of which a pixel signal programmed in the SRAM is a high level. In addition, positive black particles migrate to the segment side, and negative white particles migrate to the pixel electrode 61 side when electric potentials of the plurality of segments are in the L period. As a result, the pixel 40 becomes a black display.

In addition, in a period in which electric potentials of the plurality of segments in the pixel 40 of which a pixel signal programmed in the SRAM is a low level are L, and in a period in which electric potentials of the plurality of segments in the pixel 40 of which a pixel signal programmed in the SRAM is a high level are H, an electric potential difference does not occur. For this reason, migration of particles does not occur, and a display state is maintained.

In addition, here, a case where all of the segment Seg 0 to segment Seg 60 in the matrix display mode period T2 have approximately the same electric potential at any moment has been described; however, in a configuration in which approximately the same electric potential is realized in each segment (configuration in which electric potential is not different according to portion of segment), respective segments may have a different electric potential in a certain moment in the matrix display mode period T2. That is, in the matrix display mode period T2, an electrophoretic panel using the active matrix system is realized in each of the 61 segments. According to the embodiment, as an example, a pixel 40 to which a voltage is applied using respective electric potentials of the segment Seg 1 to segment Seg 60 among 61 segments is set so as to have a configuration in which the previous image is held as is, in the matrix display mode period T2.

### Control of Electro-Optical Display Device 10 in Power Off Period T3

Hereinafter, the power off period T3 will be described.

In the power off period T3, all of the high electric potential power line 33, the low electric potential power line 34, the first control line 36, the second control line 37, and the opposing electrode 62 enter a state of being electrically disconnected from another circuit. At this time, the previously displayed image is held in the display unit 11.

### Control of Electro-Optical Display Device 10 in Segment Display Mode Period T4

Hereinafter, the segment display mode period T4 will be described.

The segment display mode period T4 is a period in which approximately the same electric potential is applied to all of the pixel electrodes 61. The electro-optical display device 10 applies a predetermined voltage to the respective segment Seg 1 to segment Seg 60 by applying approximately the same electric potential to all of the pixel electrodes 61, and changes a display of the pixel 40.

In the segment display mode period T4, the electro-optical display device 10 changes, for example, both of a value of the electric potential V1 which is applied to the pixel electrode 61 from the first control line 36, and a value of the electric potential V2 which is applied to the pixel electrode 61 from the second control line 37 to any one of a +V voltage and a zero voltage. That is, even when any one of the first transmission gate TG1 and the second transmission gate TG2 is driven, an electric potential of a +V voltage or a zero voltage is applied to the pixel electrode 61. In this manner, even in a case where an electric potential corresponding to image data which is stored in the image signal input period T1 is different in each of the plurality of pixels 40, the electro-optical display device 10 can apply approximately the same electric potential to all of the pixel electrodes 61 without correcting the electric potential which is stored in the pixel 40 by recalling the electric potential.

As a result, in the segment display mode period T4, the electro-optical display device 10 can realize an electrophoretic panel using the segment system in each of the 61 segments.

As described above, in the segment display mode period T4, the electro-optical display device 10 performs operations in order of the first segment display mode period T4-1, and the second segment display mode period T4-2.

### Control of Electro-Optical Display Device 10 in First Segment Display Mode Period T4-1

In the example, the first segment display mode period T4-1 is a period in which a black color is displayed in the pixel 40 to which a voltage is applied using a segment corresponding to the second hand S that denotes a second in the current point of time, since the electronic apparatus 1 is a watch. In the example illustrated in FIG. 9, a segment which applies a voltage to the pixel is the segment Seg 1.

In the first segment display mode period T4-1, the electro-optical display device 10 causes the common power supply modulation circuit 23 to set the electric potential V1 and the electric potential V2 to a +V voltage. In this manner, the electric potential of +V voltage is applied to all of the pixel electrodes 61.

In addition, the electro-optical display device 10 causes the common power supply modulation circuit 23 to apply the electric potential of +V voltage to all of the segments other than the segment Seg 1 among the 61 segments. In this manner, an electric potential difference does not occur between all of the segments other than the segment Seg 1 among the 61 segments and the pixel electrode 61. That is, the pixel 40 to which a voltage is applied by all of the segments other than the segment Seg 1 among the 61 segments holds the previous image as is.

Meanwhile, the electro-optical display device 10 causes the common power supply modulation circuit 23 to apply an electric potential of a zero voltage to the segment Seg 1. Due to this, there is a large electric potential difference between the segment Seg 1 and the pixel electrode 61. As a result, in the pixel 40 to which a voltage is applied by the segment Seg 1, a black color is displayed.

In this manner, in the first segment display mode period T4-1, the electro-optical display device 10 can display a black color in the pixel 40 to which a voltage is applied by a segment corresponding to the second hand S that denotes a second at the current point of time.

### Control of Electro-Optical Display Device 10 in Second Segment Display Mode Period T4-2

In the example, the second segment display mode period T4-2 is a period in which a white color is displayed (that is, display of second hand S is removed) in the pixel 40 to which a voltage is applied by a segment corresponding to the second hand S that denotes a second at a point of time before one second, since the electronic apparatus 1 is a watch. The segment that applies a voltage to the pixel 40 is the segment Seg 59. In FIG. 9, only a timing chart of the segment Seg 0 to segment Seg 2 among the 61 segments is illustrated; however, a timing chart from segment Seg 3 to segment Seg 59 in the second segment display mode period T4-2 is the same as a timing chart of the segment Seg 2.

In addition, in the second segment display mode period T4-2 is a period in which the pixel 40 to which a voltage is applied by a segment corresponding to the second hand S which is white at a point of time before one second among the plurality of pixels 40 is held in white as is.

In the second segment display mode period T4-2, the electro-optical display device 10 causes the common power supply modulation circuit 23 to set the electric potential V1 and the electric potential V2 to a zero voltage. In this manner, an electric potential of a zero voltage is applied to all of the pixel electrodes 61.

In addition, the electro-optical display device 10 causes the common power supply modulation circuit 23 to apply an electric potential of a +V voltage to all of the segments other than the segment Seg 1 among the 61 segments. In this manner, there is a large electric potential difference between all of the segments other than the segment Seg 1 among the 61 segments and the pixel electrode 61. As a result, a white color is displayed in the pixel 40 to which a voltage is applied by all of the segments other than the segment Seg 1 among the 61 segments.

Meanwhile, the electro-optical display device 10 causes the common power supply modulation circuit 23 to apply an electric potential of a zero voltage to the segment Seg 1. Due to this, an electric potential difference does not occur between the segment Seg 1 and the pixel electrode 61. As a result, a display of the pixel 40 to which a voltage is applied by the segment Seg 1 is held in black as is.

### Control of Electro-Optical Display Device 10 in Repeating Period T5

The electro-optical display device 10 repeats operations from the power off period T3 to the segment display mode period T4 58 times. That is, the electro-optical display device 10 can update a display of the second hand S of the electronic apparatus 1 as a watch at one minute intervals using the operations from the power off period T3 to the segment display mode period T5.

As described above, the electro-optical display device 10 can update displays of the minute hand M1, the hour hand M2, and the second hand S of the electronic apparatus 1 as a watch at one minute intervals by repeating the operations from the image signal input period T1 to the repeating period T5. In addition, when changing a display of the graph G, the electro-optical display device 10 performs the change of the graph G in the matrix display mode period T2.

As described above, the electro-optical display device 10 performs both the operations of the operation as the electrophoretic panel of the active matrix system, and the operation as the electrophoretic panel of the segment system. For this reason, the electro-optical display device 10 can suppress a power consumption compared to a case where all of displays of the minute hand M1, the hour hand M2, the second hand S, and the graph G are updated by being operated as the electrophoretic panel of the active matrix system. The reason for this is that, in the electro-optical display device 10, updating of a display of the second hand S is performed in the segment display mode period T4 which is not accompanied with the image signal input period T1. In addition, the electro-optical display device 10 can improve a processing speed since the image signal input period T1 is not necessary when updating a display of the second hand S. That is, the electro-optical display device 10 can perform switching of a display further rapidly. In addition, in the electro-optical display device 10, power which is necessary in a program of the SRAM is not necessary, and it is possible to reduce power consumption while performing displaying of a second.

In addition, when the electronic apparatus 1 is a watch as in the embodiment, since there is a delay in time display in a time interval from the start of the image signal input period T1 to the end of the matrix display mode period T2, it is preferable that the time interval is less than one second. In addition, the segment display mode period T4 does not accompany the image signal input period T1 as in the matrix display mode period T2. For this reason, a time interval from the start to the end of the segment display mode period T4 is shorter than a time interval from a point of time in which the image signal input period T1 starts to a point of time in which the matrix display mode period T2 ends.

### Specific Example 2 of Control Method of Electro-Optical Display Device 10

Hereinafter, specific example 2 of the control method of the electro-optical display device 10 will be described with reference to FIG. 9.

FIG. 9 is a timing chart in specific example 2 of the control method of the electro-optical display device 10. In FIG. 9, a state where the electro-optical display device 10 performs operations in order of the image signal input period T1, the matrix display mode period T2, the power off period T3, a segment display mode period T4a, and a repeating period T5a, and a display image is displayed is illustrated. In addition, since the control method of the electro-optical display device 10 in the image signal input period T1, the matrix display mode period T2, and the power off period T3 is the same as that which is described in FIG. 8, descriptions thereof will be omitted.

### Control of Electro-Optical Display Device 10 in Segment Display Mode Period T4a

Hereinafter, the segment display mode period T4a will be described.

In the segment display mode period T4a, the electro-optical display device 10 controls the common power supply modulation circuit 23 so that a value of the electric potential V1, a value of the electric potential V2, and a value of a voltage which is applied to the segment Seg 0 are repeated in a period of a +V voltage, and a period of a zero voltage.

In addition, the electro-optical display device 10 controls the common power supply modulation circuit 23 so that a value of an electric potential which is applied to the segment Seg 1 is set to a zero voltage, and a value of an electric potential which is applied to all of the segments other than the segment Seg 1 among the 61 segments is set to a +V voltage.

Due to this, there is no electric potential difference between the segment Seg 0 and the pixel electrode 61. For this reason, the pixel 40 to which a voltage is applied by the segment Seg 0 holds the previous image as is. In addition, when an electric potential of the pixel electrode 61 is a +V voltage, there is there is a large electric potential difference between the segment Seg 1 and the pixel electrode 61. As a result, a black color is displayed in the pixel 40 to which a voltage is applied by the segment Seg 1. In addition, when an electric potential of the pixel electrode 61 is a zero voltage, there is no electric potential difference between the segment Seg 1 and the pixel electrode 61. As a result, an image forming unit 70 of the pixel 40 to which a voltage is applied by the segment Seg 1 is not operated, and the previous image is held as is.

In addition, when an electric potential of the pixel electrode 61 is a +V voltage, there is no electric potential difference between all of the segments other than the segment Seg 1 among the 61 segments and the pixel electrode 61. As a result, an image forming unit 70 of the pixel 40 to which a voltage is applied by all of the segments other than the segment Seg 1 among the 61 segments is not operated, and the previous image is held as is. In addition, when an electric potential of the pixel electrode 61 is a zero voltage, there is a large electric potential difference between all of the segments other than the segment Seg 1 among the 61 segments and the pixel electrode 61. As a result, a white color is displayed in the pixel 40 to which a voltage is applied by all of the segments other than the segment Seg 1 among the 61 segments.

### Control of Electro-Optical Display Device 10 in Repeating Period T5a

The electro-optical display device 10 repeats operations from the power off period T3 to the segment display mode period T4a, which are illustrated in FIG. 9, 58 times. That is, the electro-optical display device 10 can update a display of the second hand S of the electronic apparatus 1 as a watch at one minute intervals due to operations from the power off period T3 to the segment display mode period T5a which are illustrated in FIG. 9.

As described above, when the electro-optical display device 10 controls the common power supply modulation circuit 23 so that a value of the electric potential V1, a value of the electric potential V2, and a value of a voltage which is applied to the segment Seg 0 are repeated in a period of a +V voltage, and a period of a zero voltage, it is possible to perform removing of a display of the second hand S by setting a segment corresponding to the second hand S that denotes a second of a time before one second to a white color, and displaying of the second hand S by setting a segment corresponding to the second hand S that denotes a second of the current time to a black color approximately at the same time. As a result, the electro-optical display device 10 can smoothly show a movement of a display position of the second hand S with respect to a user of the electronic apparatus 1.

### Specific Example 3 of Control Method of Electro-Optical Display Device 10

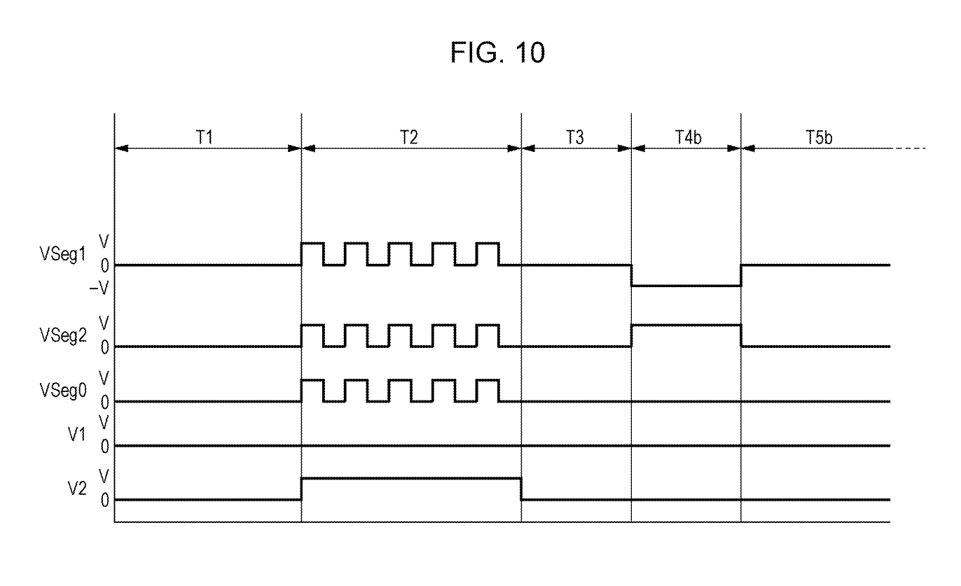

Hereinafter, specific example 3 of the control method of the electro-optical display device 10 will be described with reference to FIG. 10.

FIG. 10 is a timing chart in specific example 3 of the control method of the electro-optical display device 10. FIG. 10 illustrates a state where the electro-optical display device 10 performs operations in order of the image signal input period T1, the matrix display mode period T2, the power off period T3, a segment display mode period T4b, and a repeating period T5b, and a display image is displayed is illustrated. In addition, since the control method of the electro-optical display device 10 in the image signal input period T1, the matrix display mode period T2, and the power off period T3 is the same as that which is described in FIG. 8, descriptions thereof will be omitted.

### Control of Electro-Optical Display Device 10 in Segment Display Mode Period T4b

Hereinafter, the segment display mode period T4b will be described.

In the segment display mode period T4b, the electro-optical display device 10 controls the common power supply modulation circuit 23 so that a value of the electric potential V1, a value of the electric potential V2, and a value of a voltage which is applied to the segment Seg 0 are set to a zero voltage.

In addition, the electro-optical display device 10 controls the common power supply modulation circuit 23 so that a value of an electric potential which is applied to the segment Seg 1 is set to a −V voltage.

In addition, the electro-optical display device 10 controls the common power supply modulation circuit 23 so that a value of an electric potential which is applied to all of the segments other than the segment Seg 1 among the 61 segments is set to a +V voltage.

Due to this, there is no electric potential difference between the segment Seg 0 and the pixel electrode 61. For this reason, the pixel 40 to which a voltage is applied by the segment Seg 0 holds the previous image as is. In addition, there is a large electric potential difference between the segment Seg 1 and the pixel electrode 61. As a result, a black color is displayed in the pixel 40 to which a voltage is applied by the segment Seg 1. In addition, there also is a large electric potential difference between all of the segments other than the segment Seg 1 among the 61 segments and the pixel electrode 61. As a result, a white color is displayed in the pixel 40 to which a voltage is applied by all of the segments other than the segment Seg 1 among the 61 segments.

In addition, in the segment display mode period T4b, the electro-optical display device 10 may change any one, or both of the electric potential V1 and the electric potential V2 to any one of three values. In addition, in the segment display mode period T4b, the electro-optical display device 10 may change any one, or both of the electric potential V1 and the electric potential V2 to any one of four values or more.

### Control of Electro-Optical Display Device 10 in Repeating Period T5b

The electro-optical display device 10 repeats operations from the power off period T3 to the segment display mode period T4b, which are illustrated in FIG. 9, 58 times. That is, the electro-optical display device 10 can update a display of the second hand S of the electronic apparatus 1 as a watch at one minute intervals due to operations from the power off period T3 to the repeating period T5b which are illustrated in FIG. 9.

As described above, when the electro-optical display device 10 changes a value of a voltage which is applied to segments to any one of three values of a +V voltage, a zero voltage, and a −V voltage, it is possible to perform removing of a display of the second hand S by setting a segment corresponding to the second hand S that denotes a second of a time before one second to a white color, and displaying of the second hand S by setting a segment corresponding to the second hand S that denotes a second of the current time to a black color approximately at the same time. As a result, the electro-optical display device 10 can reduce a time for a movement of a display position of the second hand S compared to the above described specific examples 1 and 2.

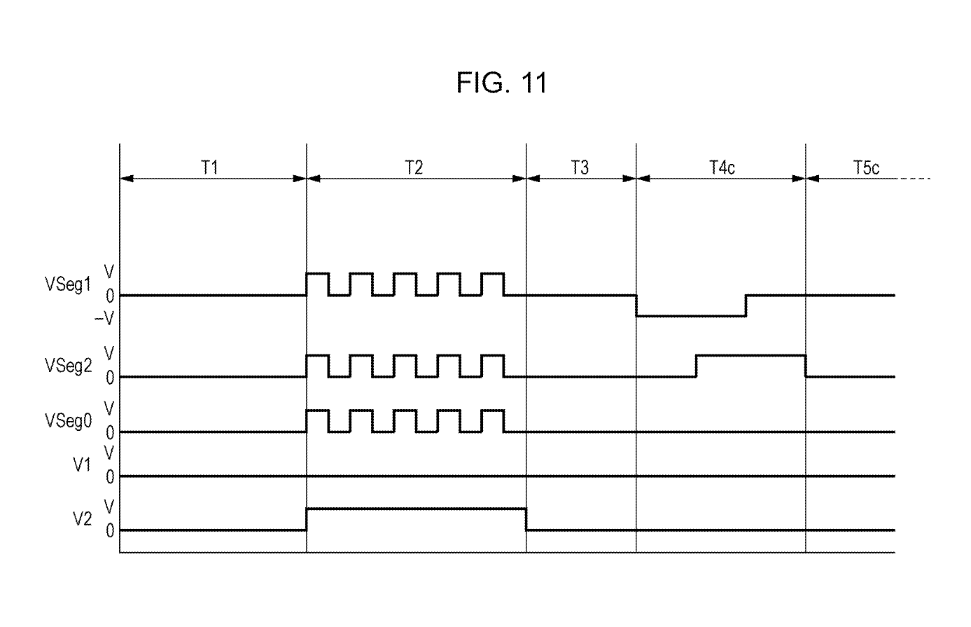

In addition, as a modification example of specific example 3, the timing chart which is illustrated in FIG. 10 may be set to a timing chart which is illustrated in FIG. 11. FIG. 11 is a diagram in which the segment display mode period T4b in the timing chart illustrated in FIG. 10 is changed to a segment display mode period T4c.

In the segment display mode period T4c, the electro-optical display device 10 sets a value of an electric potential which is applied to the segment Seg 1 to a −V voltage during a period from a start of an operation in the segment display mode period T4c to a passage of a first predetermined time, and thereafter, controls the common power supply modulation circuit 23 so that a value of the electric potential is set to a zero voltage. The first predetermined time is shorter than a time interval from the start to the end of the segment display mode period T4c.

In addition, the electro-optical display device 10 sets a value of an electric potential which is applied to all of the segments other than the segment Seg 1 among the 61 segments to a zero voltage during a period from a start of an operation in the segment display mode period T4c to a passage of a second predetermined time, and thereafter, controls the common power supply modulation circuit 23 so that a value of the electric potential is set to a +V voltage. The second predetermined time is shorter than the first predetermined time.

In this manner, a period in which a value of an electric potential which is applied to the segment Seg 1 is a −V voltage, and a period in which a value of an electric potential which is applied to all of the segments other than the segment Seg 1 among the 61 segments is a +V voltage partially overlap. As a result, the electro-optical display device 10 can smoothly show a movement of a display position of the second hand S with respect to a user of the electronic apparatus 1. That is, it is possible to show a state where a second hand S that denotes a second of a time before one second disappears, and a state where a second hand S of the current time appears at the same time with respect to a user of the electronic apparatus 1.

### Another Display Example of Electro-Optical Display Device 10

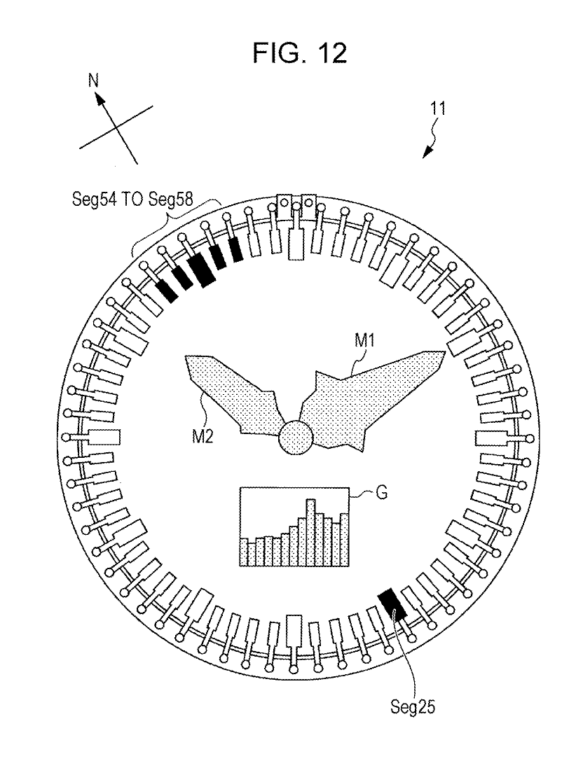

Hereinafter, another display example of the electro-optical display device 10 will be described. In the above descriptions, the configuration in which the electro-optical display device 10 causes the second hand S to be displayed using the segment Seg 1 to segment Seg 60 has been described; however, the electro-optical display device 10 may cause another display image to be displayed using the segment Seg 1 to segment Seg 60. For example, the electro-optical display device 10 may have a configuration in which a display image that denotes a predetermined direction, like an hour hand denoting a direction, is displayed, by setting a display of the pixel 40 to which a voltage is applied by a part of the segment Seg 1 to segment Seg 60 to a black color, as illustrated in FIG. 12.

FIG. 12 is a diagram illustrating another display example of the electro-optical display device 10. In the example illustrated in FIG. 12, the electro-optical display device 10 displays a display of a pixel 40 as a display image that denotes a direction of north, by setting a display of the pixel 40 to which a voltage is applied using the segment Seg 54 to segment Seg 58 to a black color. In addition, the electro-optical display device 10 displays a display of a pixel 40 as a display image that denotes a direction of south which is opposite to the direction of north by setting a display of the pixel 40 to which a voltage is applied using the segment Seg 25 to a black color.

In this manner, the electro-optical display device 10 can display a display image that denotes a predetermined direction, like an hour hand denoting a direction, by setting a display of the pixel 40 to which a voltage is applied by a part of the segment Seg 1 to segment Seg 60 to a black color.

In addition, the electro-optical display device 10 may have a configuration in which another image of which a shape is different from that of a segment is displayed in a part, or all of the segment Seg 1 to segment Seg 60 using a part, or all of the segment Seg 1 to segment Seg 60, and the pixel electrode 61, in the matrix display mode period T2.

### Multilayered Structure of Segment in Electro-Optical Display Device 10

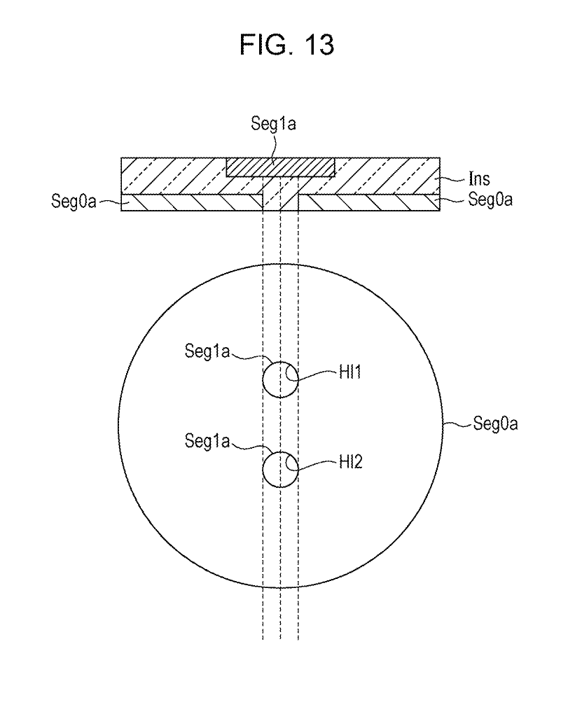

Hereinafter, a multilayered structure of segments in the electro-optical display device 10 will be described. In the above descriptions, a case where, in the electro-optical display device 10, all of segments are provided in the display unit 11 so as to be arranged in the same plane (layer) has been described; however, these segments may be arranged so as to have a multilayered structure. For example, as illustrated in FIG. 13, a segment Seg 0a and a segment Seg 1a may be arranged so as to be a two-layer structure. FIG. 13 is a diagram illustrating an example of a multilayered structure of segments in the electro-optical display device 10.

In FIG. 13, the segment Seg 0a and the segment Seg 1a are bonded by interposing an insulation layer Ins therebetween. A material of the insulation layer Ins is silicon oxide, acryl, or the like. For this reason, the insulation layer Ins is transparent. In addition, hole portions HI1 and HI2 are provided in the segment Seg 0a. The segment Seg 1a is arranged so that the hole portions HI1 and HI2 are closed when the segment Seg 0a is viewed from the display face side. In this manner, the electro-optical display device 10 can display a mark “:” by setting a display of a pixel 40 to which a voltage is applied using the segment Seg 1a to a black color, in the segment display mode period T4.

Such a multilayered structure of the segment is applied to a case where it is desired to make marks such as colon or a heart mark blink using the electro-optical display device 10, or the like.

In addition, the above described electro-optical display device 10 may have a configuration in which, for example, white particles which are positively charged, black particles which are negatively charged, and red particles which are negatively charged, and of which mobility is lower than those of the white particles and the black particles are included in the microcapsule 73 which is included in a pixel 40 to which a voltage is applied using at least one segment. Hereinafter, for ease of descriptions, such a pixel 40 is described by being referred to as a target pixel. Particles with low mobility mean, for example, particles of which a particle diameter is larger than that of the white particles or the black particles, or particles with large mass. Due to this, in the electro-optical display device 10, when a voltage of a +V voltage or a −V voltage is applied to a target pixel, due to migration of the white particles or the black particles, a display of the target pixel becomes a white color or a black color (red particles float in microcapsule 73).

In addition, since the electro-optical display device 10 can apply an arbitrary voltage to a segment only for an arbitrary time by controlling the common power supply modulation circuit 23, when a VL voltage (zero voltage<VL voltage<+V voltage) is applied to a target pixel, white particles migrates to a pixel electrode side, red particles which float migrate to a segment side, and a display of the target pixel becomes a red color. That is, a positional relationship between the white particles and the red particles is reversed. In addition, in this case, black particles also migrate to the segment side; however, it is possible to perform a display of a target pixel using only the red particles by stopping applying of the VL voltage to the target pixel before the black particles reach the segment side (before overtaking red particles).

As described above, the electro-optical display device 10 can also perform a display using another color, in addition to the white display and the black display by independently applying a predetermined voltage waveform only to a part of the plurality of segments.

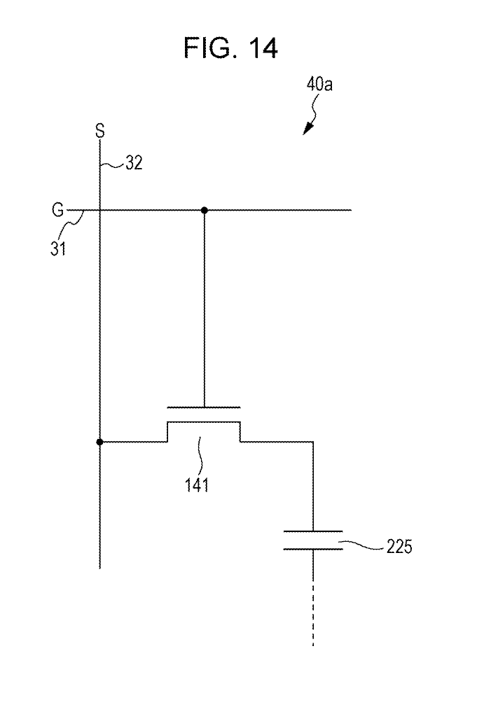

In addition, it is also possible to adopt a pixel 40a which is illustrated in FIG. 14 in the pixel 40 of the electro-optical display device 10. FIG. 14 is a diagram illustrating an example of an electrical configuration of the pixel 40a. The pixel 40a includes a selection transistor 141, a capacitor 225, a pixel electrode 61, an image forming unit 70, and a common power supply modulation circuit which is not illustrated. That is, the pixel 40a has a configuration of including a DRAM pixel circuit.

When the pixel 40a is adopted, in FIG. 3, wiring which are connected to the latch circuit 170 and the switch circuit 180 (high electric potential power line 33, low electric potential power line 34, first control line 36, and second control line 37) are not necessary.

### Another Specific Example of Electronic Apparatus Including Electro-Optical Display Device 10

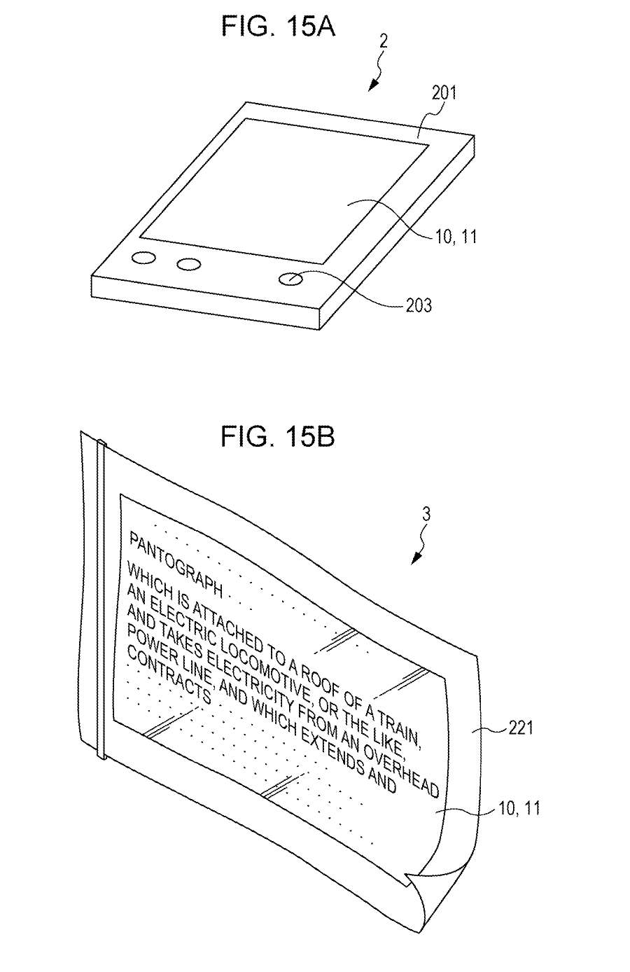

Hereinafter, another specific example of an electronic apparatus which includes the electro-optical display device 10 according to the embodiment will be described with reference to drawings. FIGS. 15A and 15B are diagrams illustrating another specific example of the electronic apparatus which includes the electro-optical display device 10 according to the embodiment. In FIG. 15A, an example of an electronic book 2 as an example of the electronic apparatus which includes the electro-optical display device 10 is illustrated. The electronic book 2 includes a frame 201 in a book shape, an operation unit 203, and a display unit 11 which is configured of the electro-optical display device 10 according to the embodiment.

In FIG. 15B, an example of electronic paper 3 as further another example of the electronic apparatus which includes the electro-optical display device 10 is illustrated. The electronic paper 3 includes a main body unit 221 which is configured of a rewritable sheet with the same texture and flexibility as those of paper, and a display unit 11 which is configured of the electro-optical display device 10 according to the embodiment.

For example, since it is assumed that a use of the electronic book, the electronic paper, or the like, is to repeatedly write characters on a background of a white ground or a black ground also in a dark place, not only in a bright place, it is preferable when the electronic book and the electronic paper can be used also in a dark place while suppressing a decrease in visibility on a displace face.

In addition, a range of the electro-optical display device 10 according to the embodiment, or an electronic apparatus which can include the electro-optical display device 10 is not limited to these, and widely includes an apparatus in which a change in color tone in vision accompanied with a movement of charged particles is used.

As described above, the electro-optical display device 10 which is included in the electronic apparatus 1 according to the embodiment causes the image forming unit 70 to form a display image based on the first display mode (matrix display mode in the example) in which approximately the same electric potential is applied to a part, or all of the segments in the opposing electrode 62, and the second display mode (segment display mode in the example) in which approximately the same electric potential is applied to the image forming unit 70 of one or more. In this manner, the electro-optical display device 10 can display a high definition image at a high speed.

In addition, the electro-optical display device 10 causes the image forming unit 70 to form a display image based on the active matrix display mode as the first display mode, and the segment display mode as the second display mode. In this manner, the electro-optical display device 10 can display a high definition image at a high speed based on the active matrix display mode, and the segment display mode.

In addition, the electro-optical display device 10 causes the image forming unit 70 to form a display image in the first display mode at a time interval that is longer than a time interval in which the image forming unit 70 is caused to form a display image in the second display mode. In this manner, the electro-optical display device 10 can suppress a frequency of forming a display image using the image forming unit 70, using the first display mode.

In the above described each segment display mode period, the electro-optical display device 10 may have a configuration in which a curve that denotes a change in voltage is changed so as to be another shape such as a configuration in which the curve is changed to a smooth curve which can be denoted using a differentiable function (for example, configuration in which curve denoting change in voltage is changed so as to draw sine curve), instead of the configuration in which any one, or both of the electric potential V1 and the electric potential V2 are changed to pulse shapes.

Hitherto, the embodiment of the invention has been described in detail with reference to drawings; however, the specific configuration is not limited to the embodiment, and may be changed, replaced, or deleted without departing from the scope of the invention.

The entire disclosure of Japanese Patent Application No. 2015-072385, filed Mar. 31, 2015 is expressly incorporated by reference herein.

What is claimed is:

1. An electro-optical display device comprising:
a first substrate on which a plurality of pixel electrodes are provided;
a second substrate on which an opposing electrode that faces the pixel electrodes and is divided into a plurality of segments is provided;
an image forming unit that is provided between the first substrate and the second substrate and forms a display image according to an electric potential applied to the pixel electrodes and an electric potential applied to the opposing electrode; and
a control unit that causes the image forming unit to form a display image based on a first display mode in which approximately the same electric potential is applied to a part or all of the segments in the opposing electrode and a second display mode in which approximately the same electric potential is applied to one or more of the pixel electrodes.

2. The electro-optical display device according to claim 1,
wherein the first display mode is an active matrix display mode, and the second display mode is a segment display mode.

3. The electro-optical display device according to claim 1,
wherein a time interval in which the image forming unit forms a display image in the first display mode is longer than a time interval in which the image forming unit forms a display image in the second display mode.

4. An electronic apparatus comprising:
the electro-optical display device according to claim 1.

5. An electronic apparatus comprising:
the electro-optical display device according to claim 2.

6. An electronic apparatus comprising:
the electro-optical display device according to claim 3.

7. A driving method of an electro-optical display device that includes a first substrate on which a plurality of pixel electrodes are provided; a second substrate on which an opposing electrode that faces the pixel electrodes and is divided into a plurality of segments is provided; and an image forming unit that is provided between the first substrate and the second substrate and forms a display image according to an electric potential applied to the pixel electrodes and an electric potential applied to the opposing electrode, the driving method comprising:
causing the image forming unit to form a display image based on a first display mode in which approximately the same electric potential is applied to a part or all of the segments in the opposing electrode and a second display mode in which approximately the same electric potential is applied to one or more of the pixel electrodes.
